(19) United States
(12) Patent Application Publication
(10) Pub. No.: US 2025/0221418 A1
(43) Pub. Date: Jul. 10, 2025

(54) CARRIER-BASED AGRICULTURAL BIOFERTILIZER COMPOSITION FOR ENHANCED DISEASE MANAGEMENT IN LEGUMES

(71) Applicants: BENOY BERRY, LONDON (GB); PRAVEEN KUMAR DIVVELA, WEST GODAVARI (IN)

(72) Inventors: BENOY BERRY, LONDON (GB); PRAVEEN KUMAR DIVVELA, WEST GODAVARI (IN)

(21) Appl. No.: 19/091,920

(22) Filed: Mar. 27, 2025

(30) Foreign Application Priority Data
Mar. 28, 2024 (GB) GB2404438.0

(51) Int. Cl. A01N 63/38; A01P 3/00; C05F 11/08

(52) U.S. Cl. CPC A01N 63/38; A01P 3/00; C05F 11/08

(57) ABSTRACT

Exemplary embodiments of the present disclosure are directed towards a carrier-based agricultural biofertilizer composition for enhanced disease management in legumes includes, an isolated Trichoderma harzianum CGAJ2T-3 having the deposit accession number KY495199 and an agriculturally acceptable solid and liquid formulation with a stabilizer to provide stability and support for at least one of the Trichoderma species, thereby enhancing the disease management efficacy and overall health of the plants.

### CROSS-REFERENCE TO RELATED APPLICATIONS

This patent application claims priority benefit of UK Patent Application No: GB2404438.0, entitled “A CARRIER-BASED AGRICULTURAL BIOFERTILIZER COMPOSITION FOR ENHANCED DISEASE MANAGEMENT IN LEGUMES”, filed on 28 Mar. 2024. The entire contents of the patent application are hereby incorporated by reference herein in its entirety.

### TECHNICAL FIELD

The present disclosure generally relates to microbial biofertilizer compositions, more particularly, the invention relates to a carrier-based agricultural biofertilizer composition for enhanced disease management in legumes.

### BACKGROUND

Enhancing the efficiency of agricultural biofertilizers through continuous developmental research holds the potential to bolster their efficacy and play a pivotal role in advancing sustainable farming practices Fungal biofertilizer compositions represent a significant advancement in the realm of sustainable agriculture, addressing the limitations and ecological concerns associated with conventional fertilizers. These innovative formulations harness the natural symbiotic relationships between fungi and plants to enhance nutrient uptake, promote soil health, and bolster crop resilience. By leveraging the unique attributes of various fungal species, these compositions offer a tailored approach to nutrient delivery and soil enrichment. Unlike synthetic fertilizers that often lead to imbalanced nutrient levels and environmental degradation, fungal biofertilizer compositions prioritize long-term soil fertility, reduced chemical input, and minimized nutrient runoff.

Trichoderma harzianum, a versatile biocontrol agent, has captured attention due to its efficacy against a diverse array of plant diseases. Its potency in disease management arises from its multifaceted strategies. By engaging in parasitism, antibiosis, and competitive interactions for nutrients and space, Trichoderma harzianum displays mycoparasitic behavior, directly targeting pathogens. Furthermore, it triggers systemic resistance in plants, activating their inherent defense mechanisms through Induced Systemic Resistance (ISR). This dual-action approach presents a comprehensive defense against diseases. A key factor in the attractiveness of Trichoderma harzianum is its adaptability. Thriving across various soil types and climates, it suits a wide range of agricultural settings. Its versatility in formulations and application techniques further enhances its utility. Notably, Trichoderma harzianum's effectiveness is underscored by its consistency; its multiple modes of action pose challenges for pathogens to develop resistance, a contrast to the susceptibility of pathogens to chemical treatments. The environmentally friendly nature of Trichoderma harzianum aligns with the goals of sustainable agriculture, appealing to both farmers and consumers. As an integral component of integrated pest management, Trichoderma harzianum holds significant promise for resilient and ecologically mindful farming systems, aligning with the ongoing shift toward safer and more sustainable agricultural practices.

Conventional farming practices come with a host of challenges and limitations that impact the environment and long-term sustainability. These practices heavily rely on chemical fertilizers, which, if misused, can lead to environmental degradation. Overapplication or improper usage of chemical fertilizers can result in water pollution and eutrophication, causing nutrient runoff into water bodies. Aquatic ecosystems may suffer as oxygen levels decline, affecting fish and other aquatic organisms. Prolonged use of chemical fertilizers without proper soil management can lead to soil degradation. Unlike chemical fertilizers that primarily focus on providing necessary nutrients to crops, they do not contribute to overall soil health improvement. Consequently, imbalanced nutrients, reduced soil fertility, loss of beneficial soil microorganisms, and compromised soil structure may lead to decreasing crop efficiency over time. Synthetic pesticides, a mainstay of conventional agriculture for disease and pest control, can inadvertently impact birds, beneficial insects, and other animals, causing biodiversity loss. This reduction in biodiversity can disrupt ecological equilibrium, compromise natural pest management efficacy, and foster pest resistance.

The production and synthesis of chemical fertilizers require significant energy inputs, largely derived from fossil fuels, exacerbating carbon emissions and contributing to climate change. Additionally, the extraction of essential components like potassium and phosphate, vital to chemical fertilizers, can deplete limited mineral resources. Prolonged exposure to chemical fertilizers and pesticides poses health risks to farmers and workers, while consumers are potentially exposed to chemical residues on crops, jeopardizing food safety. Conventional agriculture also intensifies water use and depletion, particularly in water-scarce regions. Fungal bioformulations, which integrate organic farming, bio-based fertilizers, and integrated pest management, offer sustainable alternatives. These approaches prioritize biodiversity, soil health, and long-term sustainability. By curbing reliance on non-renewable resources, minimizing environmental impact, and fostering a healthier agricultural future, fungal bioformulations promote environmentally responsible and resilient farming practices.

In the light of the aforementioned discussion, there exists a need for a certain biofertilizer formulation with novel and improved methodologies that would overcome the above-mentioned disadvantages.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An embodiment of the present disclosure is directed towards a carrier-based agricultural biofertilizer composition.

An objective of the present disclosure is directed towards harnessing the potential of an isolated Trichoderma harzianum strain, specifically CGAJ2T-3 with the deposit accession number KY495199, as a carrier-based agricultural biofertilizer composition.

An objective of the present disclosure is directed towards the development of agriculturally acceptable solid and liquid formulations, integrated with a stabilizer, which collectively ensure the stability and viability of the Trichoderma species within the composition.

An objective of the present disclosure is directed towards enhancing disease management efficacy in plants. By utilizing the Trichoderma harzianum strain in the biofertilizer composition, the invention contributes to improved resistance against a diverse range of plant diseases.

An objective of the present disclosure is directed towards promoting overall plant health. The incorporation of the isolated Trichoderma harzianum strain in the carrier-based biofertilizer composition encourages the activation of systemic resistance mechanisms, fortifying plants against various stressors.

An objective of the present disclosure is directed towards furnishing a versatile solution applicable to various agricultural settings, with the biofertilizer composition's flexibility in both solid and liquid formulations ensuring convenient application across a range of farming practices, including the treatment of scab and late leaf diseases in leguminous crops.

An objective of the present disclosure is directed towards minimizing environmental impact. By employing Trichoderma harzianum CGAJ2T-3, the invention offers a sustainable alternative to chemical interventions, reducing the release of harmful substances into the environment.

An objective of the present disclosure is directed towards curbing reliance on conventional pesticides. The integration of Trichoderma harzianum in the biofertilizer composition diminishes the need for synthetic chemicals, fostering a more ecologically balanced approach to pest and disease management.

An objective of the present disclosure is directed towards optimizing nutrient utilization and enhancing crop yields. The carrier-based biofertilizer composition fosters efficient nutrient uptake by plants, facilitated by symbiotic interactions with Trichoderma species.

An objective of the present disclosure is to promote long-term soil health and fertility by leveraging the biofertilizer composition, which is fortified by an agriculturally acceptable solid and liquid formulation, leading to the enrichment of soil microbiota and structure over time.

An objective of the present disclosure is directed towards providing an efficient and environmentally friendly approach to disease management and plant health enhancement, thereby supporting the objectives of eco-conscious farming practices.

Another objective of the present disclosure is directed towards mitigating the drawbacks of conventional fertilizers by introducing the carrier-based biofertilizer composition, which contributes to alleviating nutrient imbalances, curbing nutrient runoff, and thereby mitigating the adverse effects linked to chemical fertilization.

A further objective of the present disclosure is directed towards enhancing agricultural resilience through the inclusion of Trichoderma harzianum in the biofertilizer composition, reinforcing plants' innate defense mechanisms and increasing their ability to endure diverse environmental stresses.

An additional objective of the present disclosure is directed towards securing the food supply chains by fortifying plant health and disease resistance, thus bolstering the stability and dependability of agricultural production and safeguarding both local and global food resources.

An objective of the present disclosure is directed towards treating diseases in leguminous crops.

Furthermore, the objects and advantages of this invention will become apparent from the following description and the accompanying annexed drawings.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a flowchart depicting a method for preparing a carrier-based agricultural biofertilizer composition for enhanced disease management in legumes.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

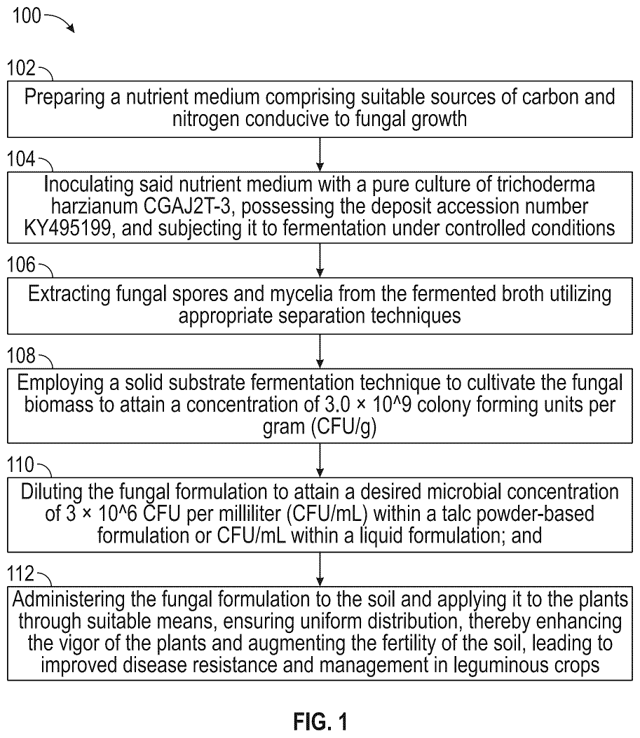

Referring to FIG. 1 is a flowchart depicting a method for preparing a carrier-based agricultural biofertilizer composition for enhanced disease management in legumes. The method commences at step 102, preparing a nutrient medium comprising suitable sources of carbon and nitrogen conducive to fungal growth. At step 104, inoculating said nutrient medium with a pure culture of Trichoderma harzianum CGAJ2T-3, possessing the deposit accession number KY495199, and subjecting it to fermentation under controlled conditions. extracting fungal spores and mycelia from the fermented broth utilizing appropriate separation techniques at step 106. Thereafter at step 108, employing a solid substrate fermentation technique to cultivate the fungal biomass to attain a concentration of 3.0×10\hat{ }9 colony forming units per gram (CFU/g). At step 110, diluting the fungal formulation to attain a desired microbial concentration of 3×10\hat{ }6 CFU per milliliter (CFU/mL) within a talc powder-based formulation or CFU/mL within a liquid formulation. Thereafter at step 112, administering the fungal formulation to the soil and applying it to the plants through suitable means, ensuring uniform distribution, thereby enhancing the vigor of the plants and augmenting the fertility of the soil, leading to improved disease resistance and management in leguminous crops.

In an embodiment of the present disclosure, the biofertilizer composition may include biologically active chemicals that may use to treat plant fungal illnesses (such as “Scab and late leaf spot” disease). The composition may include a carrier, usually talc powder and carboxy methyl cellulose, and fungal biomass from species chosen for their effectiveness in maintaining plant health or controlling diseases. A fungicidally effective quantity of the biocontrol formulation may be used in the biofertilizer composition. The process of preparation may include growing the selected fungus to promote the creation of hardy spores or survival structures, blending the biomass, combining it with the carrier, and then desiccating the mixture. After activation, the dried preparation may be applied to soil, nearby growing substrate, or used to coat seeds. The germinating spores may produce vegetative cells that may efficiently combat specific plant diseases or nay improve general plant health.

In an embodiment of the present disclosure, both sexually and asexually produced spores may be used by fungi to reproduce. Some spore forms, such chlamydospores and ascospores, may exhibit exceptional resistance to unfavorable environmental conditions like heat, dryness, pH imbalances, and nutrient deprivation. The numerous asexually derived spores may be produced by these resilient spores over prolonged favorable times may withstand tough conditions and resume germination when conditions are better. Fast fungal growth may be made possible by this.

Metabolically active fungus may be around the plant pathogen in order for fungal biocontrol against diseases of plants, such as those described above, to be effective. This may be near seeds that are beginning to germinate or close to the root system. The antagonist fungi's ability to coexist with the diseases and possibly assault the plant is essential for effective biocontrol. Additionally, the antagonistic fungi may be present in the early phases of plant development, particularly when roots grow and plants are most vulnerable to fungal infections.

These requirements may be satisfactorily satisfied by the delivery method as outlined. When used in agricultural and consumer situations, the carrier-biomass combination may demonstrate versatility. The biocontrol fungi may penetrate the diseased plant completely due to its architecture. The desiccated product may be sprinkled directly onto the plant and soil or soilless mix intended for seed or seedling planting, or it may be mixed in. When using the biocontrol formulation as a soil drench, it may be recommended to mix it with formic acid, even if it is technically still possible. As an alternative, water may be used with the substance to create a straightforward aqueous solution. The substance may also be useful as a seed covering. Whatever the method, after the soil and biocontrol product are hydrated, the spores may begin to germinate in the soil and act as biocontrol agents on the plant.

In an exemplary embodiment, an isolated Trichoderma harzianum strain CGAJ2T-3 may be derived from the vegetable field located in Yola, Nigeria. This strain may have been incorporated into a biofertilizer formulation that may be designed to significantly biocontrol Scab disease on Cowpea and late leaf spot disease in Groundnut during both rainy and dry seasons. The chosen strain may demonstrate its efficacy in effectively controlling diseases and promoting plant growth and overall plant health by inducing plant systemic resistance.

Morphological Characteristics of the Trichoderma harzianum strain CGAJ2T-3:
Growth: Rapid, cottony or woolly colonies, white to light green.
Hyphal Structure: Branched, septate, hyaline hyphae, hook-like tips.
Spores: Conidiophores produce one-celled, smooth-walled, hyaline conidia.
Chains: Conidia in linear chains on conidiophores.
Coloration: Conidia change from hyaline to greenish, yellowish, or brownish.
Chlamydospores: Spherical, thick-walled resting structures.

In another exemplary embodiment of the present disclosure, the fermentation may persist until sporulation is achieved. Induction of sporulation may involve nutrient depletion or alternative methods like heat or temperature shock. Particularly with biocontrol fungi like Trichoderma harzianum, the preference may lie in obtaining chlamydospore-rich biomass. These resilient spores, rather than conidia, serve as the biocontrol fungi's survival structures for long duration in plant environment.

According to one exemplary embodiment of the present disclosure, a readily available solid substrate may be used in solid-state fermentation. Until a significant number of viable spores, or at least 10⁸ CFU per gram of dry biomass, develop, the process may continue. The mass of sporulated cells may be gathered. In an ideal scenario, the cell mass may go through prior concentration, eliminating the need to maintain both the culture media and the cell mass. This may enhance the biocontrol agent's concentration while also streamlining the processes. Prior to being added to the talc powder, the wet or moist biomass may be homogenized or blended.

According to one exemplary embodiment of the present disclosure, to prepare the biofertilizer formulation, talc powder may be combined with the biomass and spores, along with the addition of CMC as a stabilizing agent. Distilled water may be employed to exclude spores in liquid formulations, while in granular formulations, the spores may potentially be enveloped within organic granules.

According to one exemplary embodiment of the present disclosure, a preventative acid treatment may be applied to the biocontrol agent to stop bacterial development in the biofertilizer formulation. By using diluted acid at this stage, airborne bacteria may be prevented from multiplying on the drying biomass/carrier amalgamation.

According to one exemplary embodiment of the present disclosure, talc powder and CMC may be selected as carrier materials due to their potential to effectively promote fungal growth, all the while being compatible with the surrounding plant environment. The biocontrol component of biofertilizer formulation may be preferably formulated utilizing talc powder and CMC, with commercially available wettable powder talc being a preferred option. To optimize the applicability of talc powder, the preparation of the biofertilizer formulation may involve measures to eliminate microbiological contamination, which may entail prolonged heating (possibly exceeding 48 hours) or irradiation at temperatures like 100° C. to 110° C. or higher. Additionally, chemical sterilization may also be considered to impede the fungus's health and growth.

The combined biomass/acid mixture may then be added to the talc powder and CMC mixture through any preferable method. This approach may alleviate the necessity for sterile conditions when generating biomass with the utilization of CMC and talc powder. While sterile facilities are primarily essential during phases of biomass culture, conventional techniques for mixing, measuring, and transporting the biomass-talc powder and CMC combination may allow for non-sterile manipulation. This may simplify the procedures for handling and preparation.

The biomass/acid mixture may be added to the CMC and talc powder in a ratio of 1.00%: (Spore of Trichoderma sp. contains 2×106 CFU/gm), 98.50% (Talc powder) and 0.50% (Carboxy methyl cellulose). The biomass, CMC, and talc powder may be thoroughly mixed.

This combined mixture may be gradually dried until the total volatile content drops below 10.0%, preferably below 2.0%. Lower volatiles levels may inhibit bacterial and fungal growth, potentially facilitating the storage of the biocontrol preparation. The emphasis on achieving maximum dryness may be preferred to minimize growth. For instance, air drying following the deposition of thin layers (approximately 2.0 cm thick) may be a suitable approach. The desiccated biocontrol product may have a shelf life of at least six weeks while remaining stable.

The dehydrated fungal product may appear as smooth, pale texture, and uniformly dispersed particles offer efficient application. Depending on the characteristics of the fungus, particles typically may have dark colors and solid substrates.

In another exemplary embodiment of the present disclosure, Trichoderma harzianum may be isolated from the alkaline calcareous soil of rhizosphere and rhizoplane from Yola, Nigeria through serial dilution technique and spread plate method.

The biofertilizer formulation may contain fungal spores in sufficient quantity that may a viable spore count of at least about 10⁶ colony-forming units (CFU) per gram of the dried biomass of the product. A CFU is a measure of the viability of the spore preparation. A useful range is about 10⁴ to about 10¹⁰, preferably about 10⁶ to about 10⁸, CFU per gram. It should be appreciated that the preferred spore count of the dried material may depend on the anticipated dosage used in the soil or liquid mix or on seeds that are easily applied on the infected area of the plant after post-disease mixed with soil before plantation.

In another exemplary embodiment of the present disclosure, the dried biocontrol agents may be applied to the plant (via spray or drench to the soil) and/or mixed with the soil in which plants to be protected by the biocontrol agent will be grown. The plant seeds may be coated with the dried sporulated biomass product. For example, the seeds may be tumbled with the dried material in a sticky substance such as CMC until coated. The biofertilizer formulation may allow for activation of the fungal spores on the carrier so that the carrier/biomass formulation, when added to soil or plant part, permits the growth and development of the biocontrol agent under natural conditions. After addition of the biofertilizer formulation to soil or plant part, the formulation's effectiveness may be ascertained by reduction in pathogen inoculum density and in prevention or reduction of soilborne disease. Use of the biofertilizer formulation may reduce or prevent diseases scab (caused by Sphaceloma sp.) in cowpea (Vigna unguiculata) and late leaf spot (caused by Cercospora sp.) in groundnut (Arachis hypogaea).

In another exemplary embodiment of the present disclosure, Trichoderma harzianum CGAJ2T-3 was isolated from the vegetable rhizosphere and rhizoplane from Yola, Nigeria.

In another exemplary embodiment of the present disclosure, Trichoderma harzianum CGAJ2T-3 was isolated by a serial dilution technique and spread plate method.

In another exemplary embodiment of the present disclosure, the agriculturally acceptable solid formulation comprises carriers selected from the group consisting of talc, vermiculite, peat, and compost, providing a suitable matrix for sustained release and growth of Trichoderma harzianum CGAJ2T-3.

In another exemplary embodiment of the present disclosure, Trichoderma harzianum CGAJ2T-3 has the ability to reduce the growth of fungal plant pathogens in vitro and can produce hydrolytic enzymes, thereby regulating plant disease and growth, improving root development, and enhancing overall plant vigor.

In another exemplary embodiment of the present disclosure, the nutrient medium comprises a combination of carbon and nitrogen sources, selected from the group consisting of sucrose, glucose, malt extract, and peptone, to provide an optimal growth environment for Trichoderma harzianum CGAJ2T-3.

In another exemplary embodiment of the present disclosure, the separation techniques for extracting fungal spores and mycelia comprise methods such as filtration, centrifugation, or a combination thereof, ensuring efficient isolation from the fermented broth.

In another exemplary embodiment of the present disclosure, the solid substrate fermentation method utilizes a mixture of agricultural by-products and supplements, including rice bran and wheat straw, to facilitate the growth and biomass production of Trichoderma harzianum CGAJ2T-3.

In another exemplary embodiment of the present disclosure, the application of the biofertilizer composition to the plants involves spraying onto foliage or root zones using conventional spraying equipment, facilitating even coverage and uptake by the plants.

### Example-1

Process for isolation and cultivation of Trichoderma harzianum from the vegetable rhizosphere: A method for isolating and cultivating Trichoderma harzianum from the rhizosphere of vegetables may the steps of:
a. Obtaining a representative sample containing Trichoderma harzianum from either rhizosphere soil or using a sterile instrument to collect a soil core.
b. Preparing a nutrient medium containing suitable carbon and nitrogen sources. Autoclave the plates for sterilization and permit them to cool to ambient temperature, that are designated for the purpose of isolating Trichoderma harzianum from the soil sample.
c. Taking a small portion of the soil sample and uniformly distribute it across the surface of agar plates containing a growth medium, specifically Trichoderma harzianum Specific Media (TSM). The TSM may comprise a basal medium composed of the following per liter: 0.2 g of MgSO₄ 7H₂O, 0.9 g of K₂HPO₄, 1.0 g of NH₄NO₃, 0.15 g of KCl, 0.15 g of rose Bengal, 3 g of glucose, and 20 g of agar in 950 ml of distilled water. The mixture may undergo autoclaving at 121° C. for 15 minutes. Furthermore, antimicrobial and fungicidal constituents such as 0.25 g of chloramphenicol, 9.0 ml of a streptomycin stock solution (1% wt/vol), 0.2 g of quintozene, and 1.2 ml of propamocarb (with 772 g of active ingredient per liter) may be dissolved in 40 ml of sterile distilled water. These components are then combined and introduced to the cooled basal medium.
d. Incubating the plates at temperatures within a predetermined range of 25-27° C. for a duration of 72-96 hours after spreading. Upon completion of the incubation period, Trichoderma harzianum colonies may be visibly distinguishable on the nutrient agar plates
e. Selecting a single colony and then transfer the selected colony onto fresh agar plates to cultivate pure cultures.
f. Preserving the spores from the pure cultures by storing them in a 50% glycerol solution, thereby ensuring their viability for future applications.

### Example-2

Molecular characterisation: Utilizing its diverse range of beneficial characteristics, the strain may undergo molecular identification through DNA isolation. Ribosomal DNA (rDNA) may selectively be amplified by utilizing ITS-1 (Forward) and ITS-4 (Reverse) primers, with the resulting amplified product later subjected to partial sequencing provided by MACROGEN, located in Korea. The resultant sequence data may undergo comprehensive bioinformatics analysis, including thorough examination through BLAST (Basic Local Alignment Search Tool) on the United States National Center for Biotechnology Information (NCBI) database. This analysis may conclusively confirm the organism's identity as Trichoderma harzianum. Subsequently, the accession code KY495199 was assigned to the mentioned strain following retrieval from the NCBI repository.

### Example-3

In-vitro biocontrol efficacy: To conduct an in-vitro experiment evaluating biocontrol efficacy against Alternaria sp., Fusarium sp., and Aspergillus sp. fungal pathogens, a preferred methodical approach may be utilized. The essential elements may involve obtaining pure cultures of the fungal pathogens, utilizing potential biocontrol agents-either commercial formulations or isolated antagonistic microorganisms-species-specific growth media such as Potato Dextrose Agar (PDA), Petri dishes, sterile water, an incubator set to the suitable temperature and lighting conditions, and precise measuring tools like rulers, calipers, or software applications for quantifying colonies.

The procedural sequence may commence with the preparation of biocontrol agents, which may be carried out according to manufacturer specifications or established laboratory protocols. In cases where antagonistic microorganisms are isolated, their propagation within suitable growth media may be pursued. Subsequently, distinct pure cultures of Alternaria sp., Fusarium sp., and Aspergillus sp. may be obtained from infected plant tissues or alternative sources. Cultivation on growth media suitable for each species may yield fresh spores essential for subsequent inoculation.

Concurrently, petri dishes may be prepared with specific growth media corresponding to the unique fungal pathogens, where the use of PDA may be customary. The introduction of the pathogens onto the petri dishes may involve the aseptic transfer of small spore quantities from each respective culture using a sterile inoculation loop or needle.

The subsequent phase may involve the application of biocontrol agents, where these agents may be introduced onto designated segments of the same petri dishes or on individual dishes. Careful spatial separation may be maintained to prevent potential cross-contamination. Control plates may also be simultaneously prepared, containing solely the pathogen inoculum, strategically providing a basis for comparative assessment with the biocontrol treatments.

The prepared petri dishes may then be placed within an incubator that may be tailored to meet the growth requirements of each fungal pathogen. Systematic monitoring of the dishes may follow, aimed at closely observing fungal growth and developmental progress. The dimensions of fungal colonies may be meticulously measured using accurate tools such as rulers, calipers, or specialized image analysis software. These measurements may be systematically recorded for each treatment throughout the designated time frame.

Following data collection, thorough statistical analysis, potentially involving methodologies like ANOVA, may be conducted to identify significant differences in growth inhibition between the biocontrol-treated and control samples. This information can provide valuable insights into the effectiveness of the tested biocontrol agents against Alternaria sp., Fusarium sp., and Aspergillus sp. pathogens. The results may indicate that cowpea, groundnut, and soybean seeds inoculated with Trichoderma harzianum significantly inhibited the growth of Alternaria sp., Fusarium sp., and Aspergillus sp. pathogens compared to the control group.

### Example-4

Preparation of Mother Culture: The isolated strain may undergo a subculture on TSM agar medium on small discs, which may subsequently incubate in a dark environment. Following incubation, there small discs may carefully extract and introduced into a conical flask containing TSM Broth medium. This flask may then place in an incubator for a duration of 10 days. Once the incubation period concludes, the cultivated spores and mycelium may be collected and utilized for the subsequent stage of solid fermentation.

### Example-5

Solid-state fermentation: Solid-state fermentation is a prominent technique that may be employed for harnessing the biocontrol potential of Trichoderma species, which is renowned for its capacity to suppress plant pathogens effectively. A methodical approach for conducting solid-state fermentation of Trichoderma harzianum on maize substrate, utilizing the ensuing steps:

Materials Needed: 1.5 kg maize grains (coarse); Trichoderma harzianum inoculum (spores or mycelium)—approximately 20-50 ml; Sterile water to maintain moisture; Containers with lids; Incubation chamber.

Preparation of Maize Substrate: Begin by thoroughly cleaning 1.5 kg of maize grains. Washing the grains to remove any dust or impurities, then grind them into a coarse flour substrate. Subsequently, immersing the flour substrate in water for a duration of 4-6 hours to ensure proper hydration.

Sterilization of Substrate: Draining any excess water from the maize substrate after the hydration phase. Employing either steam or autoclaving methods that may subject the maize grains to a temperature of 121° C. for 1 hour to ensure sterility. Repeating the sterilization process thrice consecutively.

Cooling and Equilibration: Facilitating the cooling of the maize grains to room temperature within a sterile environment. Further equilibrating the substrate's moisture content to approximately 60-70% by cautiously incorporating small quantities of sterile water while continuously mixing until the desired moisture level is achieved.

Inoculation with Trichoderma harzianum: Utilizing a pre-prepared Trichoderma harzianum inoculum, which may involve a 20-50 mL Trichoderma harzianum broth enriched with spores or mycelium, introduce it into the substrate. Ensuring a comprehensive and even distribution of the Trichoderma harzianum inoculum within the equilibrated maize substrate.

Filling and Packing: Transferring the inoculated substrate into containers fitted with lids. Allocating approximately 500 grams of the inoculated substrate per container, ensuring there's reserved headspace of about 20-30% to accommodate potential expansion during fermentation. Utilizing a gentle packing method that may eliminate air pockets and encourage even colonization.

Sealing and Incubation: Securely sealing the containers to establish a confined environment conducive to fermentation. Incubating the containers/bags within an ambient temperature range of 25-30° C. and sustain a relative humidity of 70-80%. These conditions typically may foster optimal growth of Trichoderma harzianum.

Monitoring and Maintenance: Performing periodic checks on the substrate's moisture content, implementing necessary adjustments to prevent excessive moisture or desiccation. Vigilantly scrutinize for any indications of contamination or irregular growth. Promptly discarding the affected containers/bags in case of contamination.

Harvesting: After a fermentation span of 12-14 days, the maize substrate may be successfully colonized by Trichoderma harzianum. Exercising care while unsealing the containers or bags, and subsequently harvesting the fermented product.

Storage: Preserving the harvested product within hermetically sealed containers, storing it in a cool, dry locale to uphold its quality and efficacy.

### Example-6

Inoculation effect of Trichoderma harzianum formulation on cowpea, groundnut, and soybean seed emergence:

Materials Needed: Cowpea, groundnut, and soybean seeds (50 seeds per treatment); Trichoderma harzianum formulation (laboratory-prepared—Example 2); Sterile water; Trays for seed germination; Sterile potting mix or soil

Seed Treatment: Dividing each crop's seeds into groups of 50 seeds for each treatment (inoculated and non-inoculated). Immersing the seeds designated for the inoculated treatment in the prepared Trichoderma harzianum formulation for a sufficient time (60 minutes) to allow adherence. Keeping an equivalent set of seeds for each crop as a control without Trichoderma harzianum treatment. Filling germination trays or containers with sterile potting mix. Planting 50 treated seeds and 50 control seeds of each crop evenly in separate rows in the germination trays. Watering the seeds gently to ensure proper moisture levels. Labeling each tray with crop type, treatment (inoculated or control), and date. Placing the germination trays in a controlled environment with appropriate light and temperature conditions for each crop. Recording the number of emerged seedlings for each treatment and control group daily for a specific duration of 15 days. Analysing the data to determine the effect of inoculation on seedling emergence. Results illustrated that cowpea, groundnut, and soybean seeds inoculated with Trichoderma harzianum enhanced seed emergence by 32 to 37% compared to the control.

The effect of Trichoderma harzianum inoculation on the biocontrol of Sphaceloma sp. causative Scab disease on Cowpea (Vigna unguiculata) and Cercospora sp. causative late leaf spot disease on Groundnut (Arachis hypogea) may be investigated through rigorous field trials, spanning both rainy and dry seasons. The trials may meticulously executed in the 2016 rainy season, spanning from July to December 2016, and subsequently during the 2017 dry season, from January to June 2017. These trials encompassed two distinct locations, where the strain Trichoderma harzianum was employed as the biocontrol agent for both crops.

In another exemplary embodiment of the present disclosure, the procedures for planting in the field trials may involve employing a commercial seed planter, followed by potential application methods such as soil mixing (2.5 Kg of formulation per 25 kg of soil per ha broadcast during land preparation), seed treatment (10 g per kg of seed), and foliar application (5 g or 5 ml/lit of water at various time intervals: 15 days after seed treatment, 25 days after spray, 45 days after spray, and 60 days after spray). The application could be carried out using handheld sprayers to ensure optimal dispersion at a rate of 250-300 liters per hectare.

A randomized complete block design (RCBD) may be employed in all field trials, encompassing cowpea and groundnut crops. Each individual crop trial may span a substantial area of 10 acres. The experimental setup may consist of Trichoderma harzianum treatment, along with two distinct control groups: one subjected to chemical fungicide control (Carbendazim: 2 Kg/ha at the mentioned intervals) and another left untreated as a control. This triple-replicated arrangement may be meticulously adopted to examine disease incidence and the potential efficacy of biocontrol agents against pathogens. Upon reaching maturity, the crops may undergo harvesting, followed by seed collection and cleaning, enabling precise yield measurements. The enlightening results obtained from these trials may reveal a significant enhancement in yield for both cowpea and groundnut crops in comparison to their respective control groups.

Detailed comprehensive results of these findings are encompassed within Table 1 and Table 2, affirming the significant positive influence of Trichoderma harzianum inoculation on crop yield. The results may highlight the potential efficacy of Trichoderma harzianum treatments in diminishing disease incidence and augmenting agricultural productivity, thereby making notable contributions to biocontrol and abundant crop production.

TABLE 1
Effect of Trichoderma harzianum Inoculation on Cowpea disease incidence,
disease severity, grain yield.

| Disease incidence (%) | | Disease severity (%) | | Grain yield (Kg/ha) | |
|---|---|---|---|---|---|
| Location- | Location- | Location- | Location- | Location- | Location- |
| 1 | 2 | 1 | 2 | 1 | 2 |

Rainy season

| | | | | | | |
|---|---|---|---|---|---|---|
| Trichoderma | 67.01 b | 48.74 b | 19.65 b | 18.22 c | 1822.95 a | 1351.17 a |
| harzianum | | | | | | |
| CGAJ2T-3 | | | | | | |
| Funguforce | 63.33 b | 92.25 a | 22.01 b | 33.16 b | 1669.79 a | 1195.00 a |
| (Carbendazim + | | | | | | |
| Mancozeb) | | | | | | |
| Untreated control | 96.72 a | 92.41 a | 41.31 a | 72.02 a | 1037.64 b | 648.73 b |
| LSD | 3.94 | 4.47 | 1.67 | 2.51 | 108.94 | 78.80 |

Dry season

| | | | | | | |
|---|---|---|---|---|---|---|
| Trichoderma | 8.33 b | 16.73 b | 4.17 b | 15.77 b | 1766.86 a | 1329.47 a |
| harzianum | | | | | | |
| CGAJ2T-3 | | | | | | |
| Funguforce | 3.33 c | 9.77 c | 3.33 b | 9.53 c | 1423.05 b | 1268.19 a |
| (Carbendazim + | | | | | | |
| Mancozeb) | | | | | | |
| Untreated control | 11.35 a | 47.25 a | 10.53 a | 35.64 a | 1176.74 b | 883.16 b |
| LSD | 0.49 | 1.51 | 0.36 | 1.23 | 101.66 | 81.78 |

Means followed by similar letters in a column are not significantly different at 5% level of probability according to least significance difference (LSD) test.

TABLE 2
Effect of Trichoderma harzianum Inoculation on Groundnut disease incidence,
disease severity, grain yield.

| Disease | | Disease severity | | Grain | |
|---|---|---|---|---|---|
| incidence (%) | | (%) | | yield (Kg/ha) | |
| Location- | Location- | Location- | Location- | Location- | Location- |
| 1 | 2 | 1 | 2 | 1 | 2 |

Rainy season

| | | | | | | |
|---|---|---|---|---|---|---|
| Trichoderma | 20.38 b | 17.52 b | 13.37 b | 12.59 b | 1820.84 a | 1589.10 a |
| harzianum | | | | | | |
| CGAJ2T-3 | | | | | | |
| Funguforce | 21.33 b | 14.22 c | 12.80 b | 11.25 b | 1455.16 b | 1485.17 b |
| (Carbendazim + | | | | | | |
| Mancozeb) | | | | | | |
| Untreated control | 40.29 a | 42.12 a | 18.36 a | 23.18 a | 1311.83 b | 1235.68 c |
| | 1.27 | 1.22 | 0.66 | 0.73 | 68.06 | 39.21 |

Dry season

| | | | | | | |
|---|---|---|---|---|---|---|
| Trichoderma | 20.26 b | 32.88 b | 15.11 b | 25.59 b | 1668.13 a | 1541.33 a |
| harzianum | | | | | | |
| CGAJ2T-3 | | | | | | |
| Funguforce | 12.51 c | 15.46 c | 9.06 c | 10.85 c | 1588.68 a | 1460.06 a |
| (Carbendazim + | | | | | | |
| Mancozeb) | | | | | | |
| Untreated control | 47.99 a | 53.32 a | 31.11 a | 34.66 a | 1151.76 b | 1024.53 b |
| | 1.36 | 1.64 | 0.91 | 1.13 | 65.53 | 59.98 |

Means followed by similar letters in a column are not significantly different at 5% level of probability according to least significance difference (LSD) test.

### Example-7

Viability test: The Trichoderma harzianum CGAJ2T-3 may demonstrate the ability to control diseases and positively influence the germination and yield of diverse crop varieties. While certain microbes may exhibit beneficial characteristics for diverse crops, the existence of particular microbial populations within both plants and soil is chiefly influenced by factors such as substrate availability, prevalent environmental conditions (including soil moisture, pH, and organic matter content), and the competition among various microbial communities, without necessitating modification or supplementation. These advantageous microorganisms may potentially colonize plant roots, thereby improving nutrient uptake, producing growth hormones, and offering protection against diseases. This may foster an environment of enhanced plant growth and health.

In another exemplary embodiment, specific strains of advantageous fungi may not naturally occur in a given field soil or, if present, may exist in limited numbers or exhibit reduced activity, thereby failing to impart any beneficial effects on plants in an unaltered or unenhanced rhizosphere. This is true regardless of the inherent valuable traits possessed by these biocontrol fungi. In order for a fungal strain with inherent beneficial traits, to exert a positive impact on plant disease management, it may possess a competitive advantage and be a robust colonizer within the rhizosphere and plant tissues during active plant growth. It may be noted that without modifications or enhancements, it may be highly improbable for any native or naturally occurring fungi, including the fungal strain CGAJ2T-3, to confer benefits to plant health. This may highlight the importance of creating conditions that favor the colonization and effectiveness of this fungal strains.

In another exemplary embodiment, Trichoderma harzianum CGAJ2T-3 may be obtained from the rhizosphere and may show a beneficial trait of plant disease resistance, enhancing plant growth. Furthermore, laboratory cultivation techniques may be utilized to optimize the growth and population density of CGAJ2T-3, thereby maximizing its efficacy. These specific growth conditions may be identified to enhance the competitive advantage of CGAJ2T-3 when applied to the rhizosphere and spayed on the plant part, resulting in a positive impact on plant growth. In essence, the determination of growth conditions that promote the successful colonization of the rhizosphere by CGAJ2T-3 may enable its beneficial effects on plant growth, which would not be achievable under normal circumstances.

In another exemplary embodiment, a biologically pure culture of CGAJ2T-3 may be grown to prepare a stock culture. Aliquots of this stock culture were preserved in cryogenic vials in a −80° C. For production runs, frozen stock culture may be used to inoculate a flask containing nutrient broth media and under specific conditions.

In another exemplary embodiment, the fungal culture may be cultivated at a temperature range of 30-32° C. during the rainy season, and in alternative embodiments, at a temperature range of 48-50° C. during the dry season. The flask culture may then scaled up in a fermenter under similar growth conditions, resulting in increased population growth and enhanced plant growth-promoting properties of CGAJ2T-3 as the culture reaches the early stationary phase. Aliquots from the early stationary phase culture may be aseptically packaged in sterilized plastic bags. The final product may have a minimum concentration of the active ingredient, with a viability of at least 3×10⁶ colony forming units per mL. The fermented culture of strain CGAJ2T-3 may be grown under optimized conditions to ensure maximum fungal spore viability and retention of its efficacy as biocontrol agent. The Trichoderma harzianum formulation stored in sterile bags may be preserved for viable count analysis. Notably, when the formulation is subjected to different temperatures, CGAJ2T-3 exhibits a response to temperature variation. Shelf-life studies demonstrate that even after 18 months of storage at both temperatures, the minimum count of bacterial cells remains at 2×10⁶, indicating the sustained viability of the strain.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

We claim:

1. A carrier-based agricultural biofertilizer composition, comprising:
an isolated Trichoderma harzianum CGAJ2T-3 having the deposit accession number KY495199; and
an agriculturally acceptable solid and liquid formulation with a stabilizer to provide stability and support for at least one of the Trichoderma species, thereby enhancing the disease management efficacy and overall health of the plants.

2. The composition as claimed in claim 1, wherein Trichoderma harzianum CGAJ2T-3 was isolated from the vegetable rhizosphere and rhizoplane from Yola, Nigeria.

3. The composition as claimed in claim 1, wherein Trichoderma harzianum CGAJ2T-3 was isolated by a serial dilution technique and spread plate method.

4. The composition as claimed in claim 1, wherein the agriculturally acceptable solid formulation comprises carriers selected from the group consisting of talc, vermiculite, peat, and compost, providing a suitable matrix for sustained release and growth of Trichoderma harzianum CGAJ2T-3.

5. The composition as claimed in claim 1, wherein Trichoderma harzianum CGAJ2T-3 has the ability to reduce the growth of fungal plant pathogens in vitro and can produce hydrolytic enzymes, thereby regulating plant disease and growth, improving root development, and enhancing overall plant vigor.

6. A method for preparing a carrier-based agricultural biofertilizer composition for enhanced disease management in legumes, comprising the steps of:
preparing a nutrient medium comprising suitable sources of carbon and nitrogen conducive to fungal growth;
inoculating said nutrient medium with a pure culture of Trichoderma harzianum CGAJ2T-3, possessing the deposit accession number KY495199, and subjecting it to fermentation under controlled conditions;
extracting fungal spores and mycelia from the fermented broth utilizing appropriate separation techniques;
employing a solid substrate fermentation technique to cultivate the fungal biomass to attain a concentration of 3.0×10\hat{ }9 colony forming units per gram (CFU/g);
diluting the fungal formulation to attain a desired microbial concentration of 3×10\hat{ }6 CFU per milliliter (CFU/mL) within a talc powder-based formulation or CFU/mL within a liquid formulation; and
administering the fungal formulation to the soil and applying it to the plants through suitable means, ensuring uniform distribution, thereby enhancing the vigor of the plants and augmenting the fertility of the soil, leading to improved disease resistance and management in leguminous crops.

7. The method as claimed in claim 6, wherein the nutrient medium comprises a combination of carbon and nitrogen sources, selected from the group consisting of sucrose, glucose, malt extract, and peptone, to provide an optimal growth environment for Trichoderma harzianum CGAJ2T-3.

8. The method as claimed in claim 6, wherein the separation techniques for extracting fungal spores and mycelia comprise methods such as filtration, centrifugation, or a combination thereof, ensuring efficient isolation from the fermented broth.

9. The method as claimed in claim 6, wherein the solid substrate fermentation method utilizes a mixture of agricultural by-products and supplements, including rice bran and wheat straw, to facilitate the growth and biomass production of Trichoderma harzianum CGAJ2T-3.

10. The method as claimed in claim 6, wherein the application of the biofertilizer composition to the plants involves spraying onto foliage or root zones using conventional spraying equipment, facilitating even coverage and uptake by the plants.
